(19) United States
(12) Patent Application Publication
(10) Pub. No.: US 2011/0246252 A1
(43) Pub. Date: Oct. 6, 2011

(54) VEHICLE CHARGING ALLOCATION MANAGING SERVER AND VEHICLE CHARGING ALLOCATION MANAGING SYSTEM

(75) Inventor: Kenichiro UESUGI, Moriya-shi (JP)

(73) Assignees: Motion Co., Ltd., Tokyo (JP); Kanematsu Communications Limited, Tokyo (JP); Kanematsu Corporation, Kobe-shi (JP)

(21) Appl. No.: 13/118,649

(22) Filed: May 31, 2011

(30) Foreign Application Priority Data
Mar. 31, 2010 (JP) 2010-125281

(51) Int. Cl. G06F 17/00

(52) U.S. Cl. 705/7.12

(57) ABSTRACT

A vehicle charging allocation managing system containing plural charging stations each having a battery charger to charge a vehicle, a charging station managing server for managing the charging stations, and a vehicle charging allocation managing server that is connected to the charging station managing server through a communication network, and instructs vehicle allocation to allocate each of the vehicles to an appropriate one of the charging stations for charging. The vehicle charging allocation managing server has a controller for setting a vehicle charging allocation schedule for specifying a charging station and a charting time zone to charge each of the vehicles on the basis of a battery residual capacity and a battery capacity consumption plan, thereby performing vehicle allocation for charging.

### INCORPORATION BY REFERENCE

The present application claims priority under 35 U.S.C. §119 to Japanese Patent Application No. 2010-125281 filed on May 31, 2010. The content of the application is incorporated herein by reference in its entirety.

### BACKGROUND OF THE INVENTION

1. Field of the Invention

The present invention relates to a vehicle charging allocation managing server and a vehicle charging allocation managing system, and particularly to a vehicle charging allocation managing server and a vehicle charging allocation managing system that manage charging allocation of plural business vehicles.

2. Description of the Related Art

There is known a charging station for charging an electric vehicle which has a battery for driving a motor and runs while using electric power charged in the battery (for example, see JP-A-07-115732).

The charging station described in the above publication has a capacitor having a larger capacity than an in-vehicle mount battery, and the capacitor of the charging station is charged with power from a commercial power supply and also discharged to charge the in-vehicle mount battery.

More time is taken to charge the battery of an electric vehicle as compared with a gasoline-powered vehicle, and thus there is a disadvantage that an electric vehicle cannot be easily charged in a charging station when another vehicle is being charged in the charging station, so that it is impossible to make an operation schedule for the electric vehicle.

In order to overcome the above disadvantage, a technique disclosed in JP-A-2003-262525 extracts charging stations (hereinafter referred to as “surrounding charging station(s)”) existing around the present position of an electric vehicle, and supplies the position(s) of the extracted surrounding charging station(s) and available information of a charger(s) set up in the charging station(s), whereby the user of the electric vehicle concerned is supplied with information concerning a charging station at which the electric vehicle can start charging immediately or within a predetermined time after the electric vehicle arrives at the charging station.

According to the technique disclosed in JP-A-2003-262525, with respect to individual users, a charging station at which a waiting time is less can be specified on the basis of the present using statuses of charging stations, and thus this method is expected to be effective. However, with respect to business-associated users who engage in the operation of business vehicles such as a taxi business, a rental car business, a car sharing business, etc., the vehicle allocation management and the charging management for vehicles are inextricably linked with each other, and thus the operation would not work when any one of these managements is weighted.

### SUMMARY OF THE INVENTION

Therefore, an object of the present invention is to provide a vehicle charging and allocating managing server and a vehicle charging allocation managing system that can manage (control) a vehicle charging allocation schedule while suppressing an effect on operation control even when the operation of plural vehicles is controlled (managed).

In order to attain the above object, according to a first aspect of the present invention, there is provided a vehicle charging allocation managing server for managing charging of a plurality of vehicles each of which has a vehicle driving battery mounted therein, which comprises a controller for setting a vehicle charging allocation schedule for specifying a charging station and a charting time zone to charge each of the vehicles on the basis of a battery residual capacity and a battery capacity consumption plan, thereby performing vehicle allocation for charging.

According to the above construction, the controller sets the vehicle charging allocation schedule for specifying the charging station and the charting time zone to charge each of the vehicles on the basis of the battery residual capacity and the battery capacity consumption plan. Accordingly, the set vehicle charging allocation schedule is fit to the optimum timing corresponding to the battery capacity consumption plan.

In the above construction, the controller determines the battery capacity consumption plan for each of the vehicles on the basis of a predetermined working schedule for the vehicle.

According to the above construction, the battery capacity consumption plan of each vehicle is determined on the basis of the predetermined travel schedule of the vehicle. Therefore, the battery consumption plan can be more accurately grasped, and the vehicle charging allocation schedule can be more accurately set at the optimum timing.

In the above construction, each of the vehicles is a business vehicle for which an operation schedule containing the working schedule and a rest schedule is managed, and the controller obtains the working schedule and determines the battery capacity consumption plan on the basis of the obtained operation schedule.

According to the above construction, the controller obtains the operation schedule and containing the working schedule and the rest schedule, and determines the battery capacity consumption plan on the basis of the obtained operation schedule. Therefore, the vehicle charging allocation schedule can be set at the optimum timing in consideration of the working schedule and the rest schedule, and thus the effect on the business operation can be reduced.

In the above construction, when the working schedule of any one of the vehicles is changed and thus a vehicle charging allocation schedule of the vehicle is required to be changed, the controller adjusts and changes the vehicle charging allocation schedule and vehicle charging allocation schedules of the other vehicles.

According to the above construction, when the working schedule of anyone of the vehicles is changed and thus a vehicle charging allocation schedule of the vehicle is required to be changed, the controller adjusts and changes the vehicle charging allocation schedule and vehicle charging allocation schedules of the other vehicles. Therefore, the plural vehicles can be efficiently charged as a whole.

In the above construction, the charging station is managed by a charging station managing server, and the controller inquires to the charging station managing server about a usage status of the charging station corresponding to the charging station managing server through a communication network to specify the charging station and the time zone for charging.

According to the above construction, when the schedule of the vehicle allocation to the charging stations is set, it can be accurately performed in consideration of the schedule of the vehicle charging allocation to the charging stations.

In the above construction, the controller calculates the battery capacity consumption plan for each of the vehicles on the basis of at least one of a travel condition containing season, weather or a time zone, a device construction of the vehicle, a crewmember of the vehicle or a travel route.

According to the above construction, the controller calculates the battery capacity consumption plan on the basis of at least one of a travel condition containing season, weather or a time zone, a device construction of the vehicle, a crewmember of the vehicle or a travel route. Therefore, the battery capacity consumption plan can be calculated more accurately, and thus the set schedule of the vehicle allocation to the charging stations can be set at the optimum timing more accurately.

In the above construction, the controller notifies a vehicle charging allocation schedule to an in-vehicle mount device mounted in each of the vehicles through a radio communication network.

According to the above construction, the controller notifies a vehicle charging allocation schedule to an in-vehicle mount device mounted in each of the vehicles through a radio communication network. Therefore, the driver (crewmember) of each vehicle can easily and surely charge the vehicle along the vehicle charging allocation schedule.

According to a second aspect of the present invention, there is provided a vehicle charging allocation managing system for managing charging of a plurality of vehicles each of which has a vehicle driving battery, comprises: a plurality of charging stations each of which has a battery charger for charging the battery of each of the vehicles; a charging station managing server for managing the charging stations; and a vehicle charging allocation managing server that is connected to the charging station managing server through a communication network, and instructs vehicle allocation to allocate each of the vehicles to an appropriate one of the charging stations for charging, wherein the vehicle charging allocation managing server comprises a controller for setting a vehicle charging allocation schedule for specifying a charging station and a charting time zone to charge each of the vehicles on the basis of a battery residual capacity and a battery capacity consumption plan, thereby performing vehicle allocation for charging.

According to the above construction, the charging station managing server manages the charging stations. Furthermore, the vehicle charging allocation managing server instructs vehicle allocation to allocate each of the vehicles to an appropriate one of the charging stations for charging. The vehicle charging allocation managing server is connected to the charging station managing server through a communication network and comprises a controller for setting a vehicle charging allocation schedule for specifying a charging station and a charting time zone to charge each of the vehicles on the basis of a battery residual capacity and a battery capacity consumption plan, thereby performing vehicle allocation for charging when the vehicle charging allocation schedule for allocating the vehicles to the charging stations for charging.

Accordingly, the vehicle charging allocation schedule for specifying the charging station and the time zone for performing charging each vehicle is set on the basis of the battery residual amount and the battery capacity consumption plan, and thus the set vehicle charging allocation schedule is set along the optimum timing corresponding to the battery capacity consumption plan.

According to the present invention, the set vehicle charging allocation schedule is set along the optimum timing corresponding to the battery capacity consumption plan, and the vehicle charging allocation schedule can be efficiently managed with making both the operation control of the vehicles and the charging of the vehicles compatible with each other.

### BRIEF DESCRIPTION OF THE DRAWINGS

FIG. 1 is a block diagram showing the construction of a vehicle operation control system;

FIG. 2 is a block diagram showing a vehicle charging allocation managing server;

FIG. 3 is a diagram showing a data base;

FIG. 4 is a diagram showing a data format of a working data base;

FIG. 5 is a diagram showing a data format of a vehicle charging cost data base;

FIG. 6 is a diagram showing a data format of a crewmember charging cost data base;

FIG. 7 is a data format of a route information data base;

FIG. 8 is a block diagram showing the construction of a charging stand;

FIG. 9 is a block diagram showing a charging station managing server;

FIG. 10 is a diagram showing a data format of a user data base;

FIG. 11 is a data format of an accounting data base;

FIG. 12 is a diagram showing a data format of a use data base;

FIG. 13 is a block diagram showing the construction of in-vehicle mount equipment;

FIG. 14 is a flowchart showing vehicle charging allocation managing processing;

FIG. 15 is a flowchart showing processing of creating a vehicle charging allocation schedule;

FIG. 16 is a flowchart showing processing of setting a vehicle charging allocation schedule;

FIG. 17 is a flowchart showing processing of calculating travelable distance;

FIG. 18 is a sequence flowchart of charging reservation;

FIG. 19 is a diagram showing specification of a charging station;

FIG. 20 is a flowchart showing processing of reserving a charging station managing server;

FIG. 21 is a flowchart showing processing of calculating estimated charging time;

FIG. 22 is a diagram showing a creation example of a vehicle charging allocation schedule;

FIG. 23 is a flowchart showing processing of updating a vehicle charging allocation schedule;

FIG. 24 is a diagram showing processing of changing a vehicle charging allocation schedule; and

FIG. 25 is a diagram showing processing of updating a vehicle charging allocation schedule (novel reservation).

### DETAILED DESCRIPTION OF THE PREFERRED EMBODIMENTS

Preferred embodiments according to the present invention will be described with reference to the accompanying drawings.

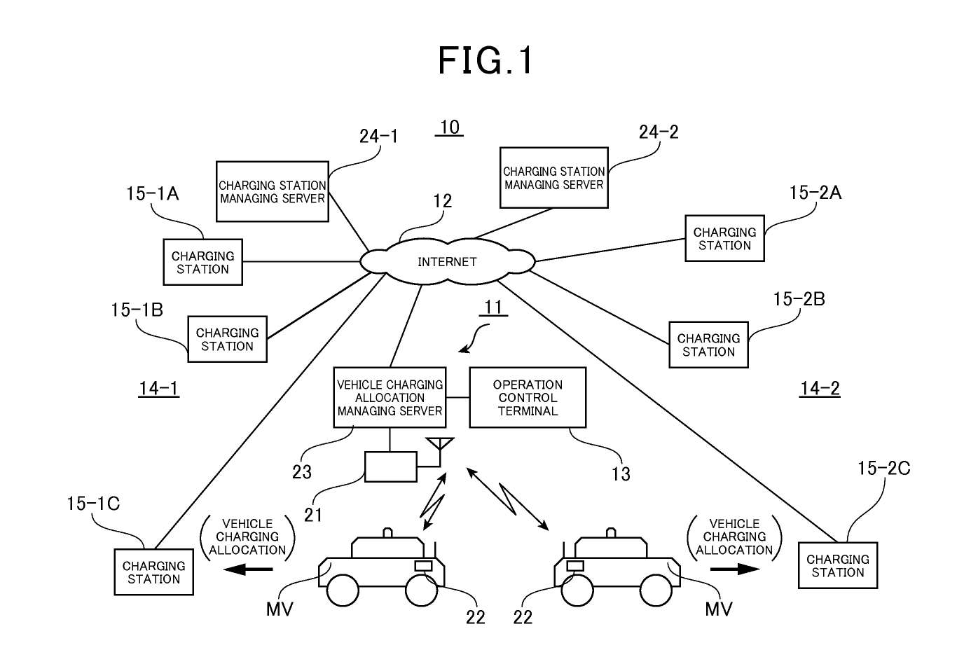

FIG. 1 is a block diagram showing the construction of a vehicle operation control system.

A vehicle charging allocation schedule managing system 10 roughly has a vehicle charging allocation managing system 11 for allocating plural business vehicles MV (for example, taxis) for charging (i.e., allocation of business vehicles to charging stations as described later to charge the business vehicles), an working (operation) control terminal 13 that is connected to the vehicle charging allocation managing system 11 to perform various managements of operation schedules such as management of vehicle allocation (allocation of business vehicles to customers) other than the vehicle charging allocation of the business vehicles, management of working schedules of crewmembers (drivers), etc., and plural charging station managing systems 14-1, 14-2 that is connected to the charging allocation managing system 11 through a communication network containing the Internet 12.

In cooperation with the plural charging station managing systems 14-1, 14-2, the vehicle charging allocation managing system 11 manages charging allocation for business vehicles MV managed by itself (hereinafter referred to as “business vehicles under management) so that the business vehicles under management go to charging stations managed by the charging station managing systems 14-1, 14-2 respectively and charged at the charging stations concerned. In this case, the vehicle charging allocation managing system 11 adjusts the operation control in cooperation with the charging station managing systems 14-1, 14-2 so that each of the business vehicles under management can be charged at a charging station in a time zone in which the charging of the business vehicle concerned is prevented as much as possible from affecting any other operation of the business vehicle than the charging operation.

The vehicle charging allocation managing system 11 also has a vehicle managing allocation managing server 23 that is connected to a radio communication device 21 and the Internet 12 and manages a vehicle charging allocation schedule.

In this case, the radio communication device 21 performs radio communication with in-vehicle mount equipment 22 mounted in a business vehicle MV having a radio communication function, and notifies a vehicle charging allocation schedule to the in-vehicle mount equipment 22 of the business vehicle MV concerned. Furthermore, the radio communication device 21 receives a business vehicle allocation schedule input thereto from the working control terminal 13 through the vehicle charging allocation managing server 23 and notifies information of business vehicle allocating destinations (maps, names, etc.) to crewmembers of the business vehicles.

Furthermore, the in-vehicle mount equipment 22 of the business vehicle MV notifies operation status data representing an actual operation status of the business vehicle MV concerned through the radio communication device 21 to the vehicle charging allocation managing server 23 or the working control terminal 13 on the basis of the position of the business vehicle concerned which is obtained by a GPS receiver (not shown).

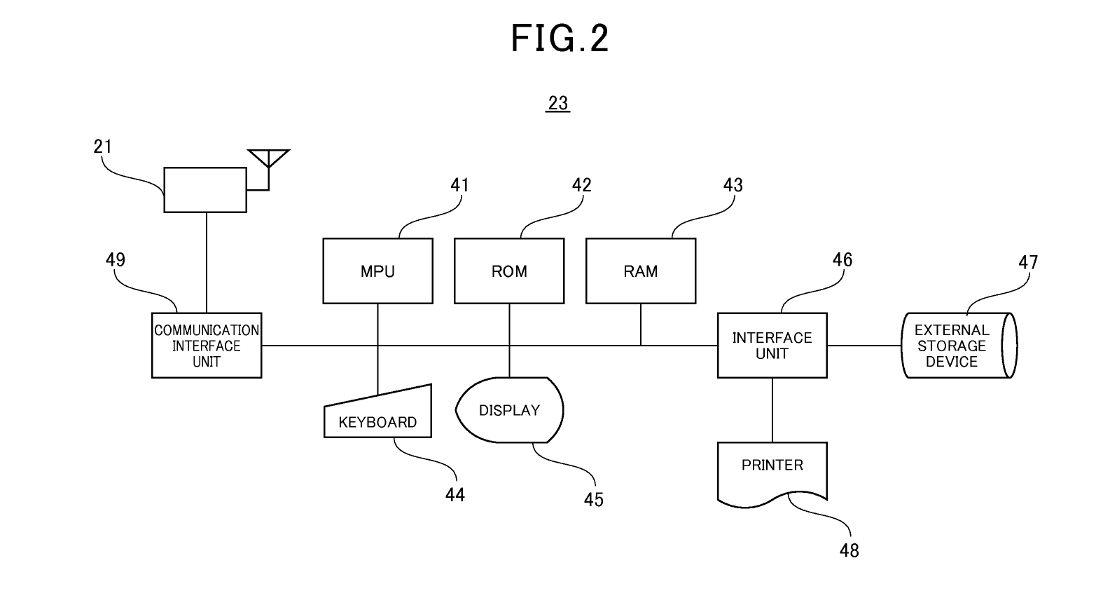

FIG. 2 is a block diagram showing the construction of the vehicle charging allocation managing server.

The vehicle charging allocation managing server 23 is configured to have the same construction as a personal computer, and has MPU 41 for concentrically controlling the vehicle charging allocation managing server 23, ROM 42 in which a program for operating MPU 41, etc. are stored, RAM 43 as a work table for temporarily storing various kinds of data, a keyboard 44 for inputting data, etc., a display 45 for displaying various kinds of information, an interface unit 46 for performing an interface operation between the vehicle charging allocation managing server 23 and each of various kinds of external equipment, an external storage device 47 such as a hard disk drive device or the like for storing data of various kinds of data bases described later, a printer 48 for printing out various kinds of information, and a communication interface unit 49 which is connected to the radio communication device 21 and the Internet 12 through a predetermined communication protocol.

Here, various kinds of data bases stored in the external storage device 47 will be described.

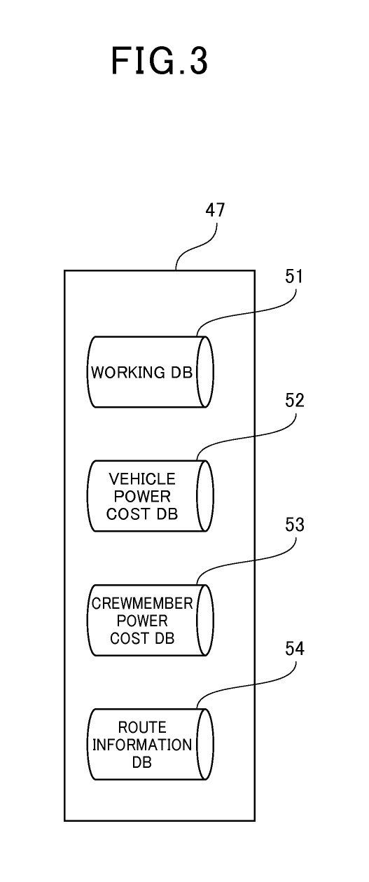

FIG. 3 shows these data bases.

The data bases stored in the external storage device 47 contain a working data base (DB) 51 for storing information concerning crewmembers, working schedules, operation statuses of the vehicles, etc. obtained from the working control terminal 13, a vehicle power cost data base (DB) 52 for storing a travelable distance per unit battery capacity (power cost) every vehicle, a crewmember power cost data base (DB) 53 for storing a travelable distance per unit battery capacity (power cost) every crewmember, and a route information data base (DB) 54 in which various kinds of information to calculate a consumption battery capacity on a set travel route are stored.

Here, with respect to the route information data base 54, a consumption battery capacity which is estimated to be consumed (a battery capacity consumption plan)) is stored with respect to each unit road such as a road which does not contain any branch point such as a crossing or the like on its way and has branch points at both the ends thereof or a road which does not contain any branch point such as a crossing or the like on its way and has a branch point at one end thereof and a dead end at the other end thereof, and also every loading weight (containing crewmember), time zone (daytime, nighttime or the like), season (use or non-use of air conditioner or the like), weather (use or non-use of wiper or the like).

In this case, with respect to one unit road, when no substantially difference exists in consumption battery capacity between a case where a vehicle runs in a first direction (for example, ascending direction) and a case where the vehicle runs in a second direction (for example, descending direction) as in the case of a road provided on the flatland, one set of consumption battery capacities are stored for the unit road concerned. However, when the consumption battery capacity greatly varies in accordance with the travel direction as in the case of an intermountain road, a slope or the like, two sets of consumption battery capacities are stored in accordance with the travel direction.

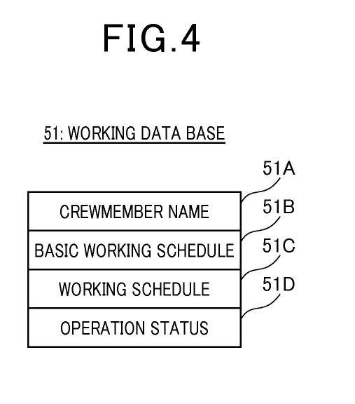

FIG. 4 is a diagram showing a data format of a working data base.

The working data base 51 has a crewmember name table 51A for storing crewmembers' names or crewmember codes corresponding to the crewmembers, a basic working schedule table 51B for storing a basic pattern of a working schedule, a working schedule table 51C for storing a working schedule obtained by modifying the basic pattern of the working schedule, and an operation status table 51D for storing the operation statuses of vehicles containing vehicle allocation information as needed.

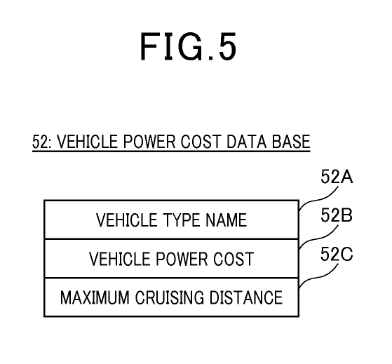

FIG. 5 is a diagram showing a data format of a vehicle power cost data base.

The vehicle power cost data base 52 has a vehicle type name table 52A for storing vehicle type names or vehicle type codes corresponding the vehicle types are stored, a vehicle power cost table 52B for storing a travelable distance per unit battery capacity (power cost) in association with travel conditions such as the type of a road (general road or express highway), the condition of a road (flat road, descending slope, ascending slope, intermountain road or the like), the condition of a vehicle (use or non-use of air conditioner, turn-on/out of headlight, use or non-use of wiper, use or non-use of in-vehicle mount accessory equipment such as CD player or the like), loading weight (containing crewmember), time zone (traffic jam time zone, bus priority lane set time zone, road-impassable time zone of specific road or the like), etc., and a maximum cruising distance table 53 for storing a maximum cruising distance at which a vehicle can travel under a fully charged state.

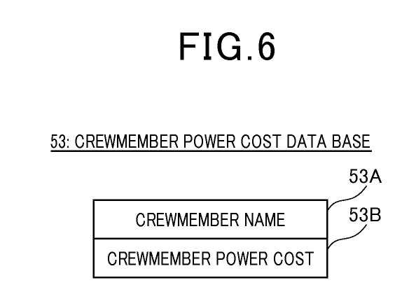

FIG. 6 is a diagram showing a data format of a crewmember power cost data base.

The crewmember power cost data base 53 has a crewmember name table 53A for storing crewmember names or crewmember codes corresponding to the crewmember names, and a crewmember power cost table 53B for storing a travelable distance per unit battery capacity (power cost) of each of the crewmembers in association with travel conditions such as such as the type of a road (general road or express highway), the condition of a road (flat road, descending slope, ascending slope, intermountain road or the like), the condition of a vehicle (use or non-use of air conditioner, turn-on/out of headlight, use or non-use of wiper, use or non-use of in-vehicle mount accessory equipment such as CD player or the like), etc.

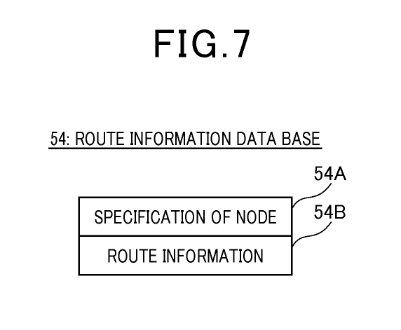

FIG. 7 is a diagram showing a data format of a route information data base.

The route information data base 54 has a node specifying table 54A for specifying a node when a road is represented by a node and a link, and a route information table 54B for storing the type of a road (general road or express highway) or the state of a road (flat road, descending slope, ascending slope, intermountain road or the like.

In this case, the route information table 54B stores route information corresponding to the state of a road every travel direction under such a condition that the power cost varies in accordance with the travel direction of the vehicle) (for example, when the vehicle ascends/descends along the same slope) even in the case of the same link (road or route). That is, stored route information is different with respect to a link connecting two nodes NA and NB between a case where the vehicle travels from the node NA to the node NB and a case where the vehicle travels from the node NB to the node NA.

Next, a charging station managing system will be described. As shown in FIG. 1, the charging station managing system 14-1 has a charging station managing server 24-1, and charging stations 15-1A to 15-1C which are connected to the charging station managing server 24-1 through the Internet 12 and perform actual charging under the control of the charging station managing server 24-1.

Likewise, the charging station managing system 14-2 has a charging station managing server 24-2, and charging stations 15-2A to 15-2C which are connected to the charging station managing server 24-2 through the Internet 12 and perform actual charging under the control of the charging station managing server 24-2.

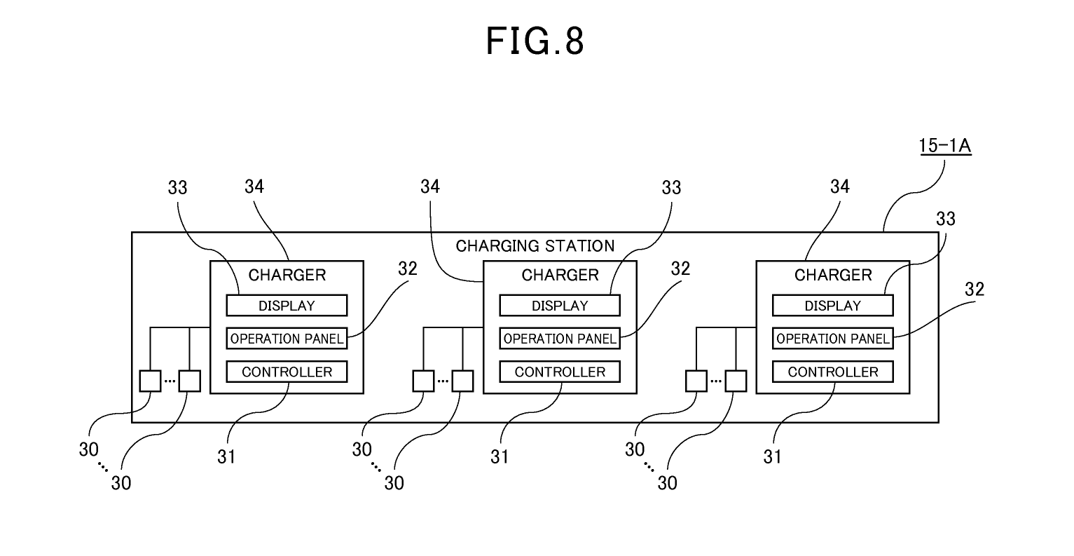

FIG. 8 is a block diagram showing the construction of the charging station.

Here, the charging stations 15-1A to 15-1C have the same construction, and thus the charging station 15-1A will be representatively described.

The charging station 15-1A has plural charging connectors (power supply connectors) 30 which are connected to an electric vehicle (mainly, power battery) under charging and supply power to the electric vehicle, and one or plural (three in an example of FIG. 8) chargers 34 each of which contains a controller 31, an operation panel 32 and a display 33.

Here, as the charging connector 30 maybe used plural kinds of connectors such as a pistol type connector having a lock mechanism such as a lock arm, a lock lever, a release lever or the like, a connector whose shape is close to the shape of a connector for a domestic electric outlet, etc.

The controller 31 is configured as a microcomputer having a communication interface, and has a communication function of performing communications through the Internet 12, a state detecting function of detecting a charging start timing, a charging terminating timing, a charging power amount and a trouble state of the charger, and a user authentication function of performing user authentication under charging. The controller 31 notifies the state detected by the state detecting function and the user authentication information obtained by the user authentication function to the charging station managing servers 24-1, 24-2 by the communication function.

Here, the state detecting function is implemented on the basis of the connection state of the charging connector 30, the measurement state of an electric energy meter (not shown) or various kinds of sensors (voltage sensor, current sensor, short-circuit sensor, etc.) (not shown) provided to the respective parts of the charger 34.

Furthermore, the user authentication function is implemented with user authentication information obtained by using a non-contact type IC card, a communication function of a cellular phone unit or the like (for example, telephone number information transmitted from a telephone line network, password information input by a user or the like).

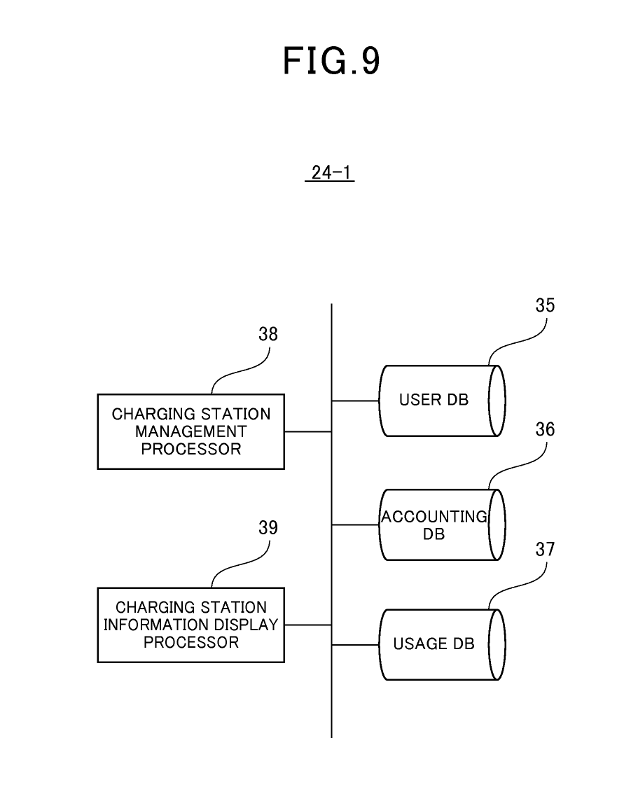

FIG. 9 is a block diagram showing the construction of the charging station managing server.

Here, the charging station managing servers 24-1, 24-2 have the same construction and thus the charging station managing server 24-1 will be representatively described.

As shown in FIG. 9, the charging station managing server 24-1 has a user data base (DB) 35 for storing user information, an accounting (charging) database (DB) 36 for storing accounting information, a usage data base (DB) 37 for storing data concerning use of the charging stations 15-1A to 15-1C, 15-2A to 15-2C by respective users, a charging station management processor 38 for managing the charging stations 15-1A to 15-1C and 15-2A to 15-2C, and a charging station information display processor 39 for performing charging station information display processing, and the respective parts are connected to one another through a bus.

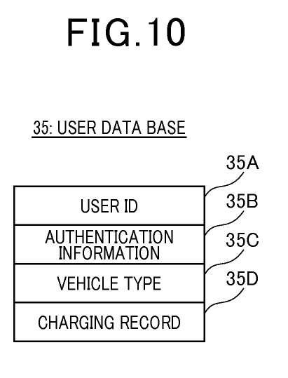

FIG. 10 is a diagram showing a data format of the user data base.

The user data base 35 stores information concerning users (individuals or corporate persons) who use the charging stations 15-1A to 15-1C and 15-2A to 15-2c, and it has a user ID table 35A in which user ID data for specifying users are stored, an authentication information table 35B in which authentication information data for user authentication are stored, a vehicle type table 35C in which vehicle type data for specifying a charging target battery, a battery charging method (charging voltage, charging current, charging type, etc.) on the basis of the vehicle type of the user are stored, and a charging record table 35D in which charging record data representing past charging record are stored.

Here, the charging record table 35D has an initial residual capacity table in which initial residual amount data representing the residual capacity of the battery at the charging start time are stored, a charging time table in which charging time data representing a time which was taken for charging are stored, a charging date data table in which charging date data representing a date at which charging was performed are stored, and a charging start time table in which charging start time data representing a charging start time are stored.

In this case, an initial voltage or the like of the battery is used as the initial residual amount data. By storing charging completion time data in place of the charging time data, the charging time may be calculated on a case-by-case basis on the basis of the charging start time data and the charging completion time data.

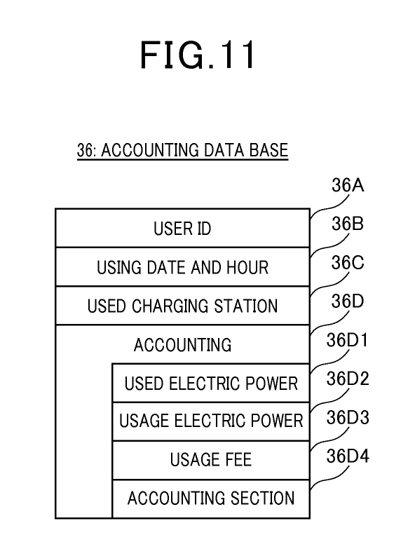

FIG. 11 is a diagram showing a data format of the accounting data base.

In this embodiment, accounting is performed on the basis of withdrawal of a charging fee from a user's bank account number, payment based on a credit card, payment based on a bank transfer in connection with issuance of an invoice or the like. Therefore, it is necessary to collect accounting data, and thus the accounting data base is constructed in the charging station managing server 24-1.

The accounting data base 36 has a user ID data table 36A in which user ID data for specifying users are stored, a use date and hour table 36B in which use date and hour representing date and hour at which the charging stations 15-1A to 15-1C are used are stored, a used charging station table 36C in which used charging station data for specifying the used charging stations 15-1A to 15-1C are stored, and an accounting table 36D in which accounting data are stored.

The accounting table 36D has a used electric power field 36D1 in which used electric power data representing the electric power used for charging are stored, an electric power unit price field 36D2 in which electric power unit price data representing electric power unit price at the using time are stored, a usage fee field 36D3 in which usage fee data corresponding to the product value between the used electric power and the electric power unit price are stored, and an accounting section field 36D4 in which accounting section data of users are stored.

When the electric power unit price varies in accordance with utilization time, plural sets of the used electric power data stored in the used electric power field 36D1 and the electric power unit price data stored in the electric power unit price field 36D2 are discriminatively stored in accordance with the utilization times.

Information necessary for actual accounting such as the debit account number, etc. are separately stored by means of prior and existing methods.

Accordingly, the amount of money to be charged is calculated on the basis of the usage fee data stored in the usage fee field 36D3 and withdrawn from the bank or the like, and also a monthly usage report and invoice is mailed to each user or put on view at a site on the Internet (not shown) so that each user is accessible thereto.

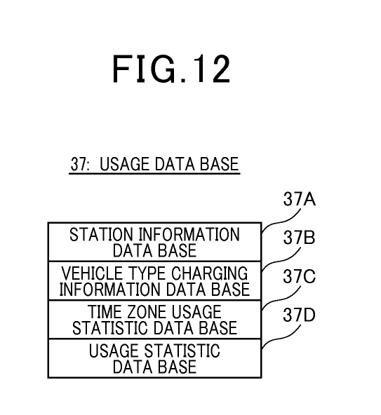

FIG. 12 is a diagram showing a data format of the usage data base.

The usage data base 37 is constructed by plural data bases, and it has a station information data base (DB) 37A in which station information such as locations of the charging stations, the number of installed chargers, business hours, business days, etc. and the charging allocation schedule of each charging station (further each charger) are stored, a vehicle type charging information data base (DB) 37B in which a charging average time required for one charging every vehicle type is stored every time zone of one day, every day of the week, every month, every season, etc., a time zone usage statistic data base (DB) 37C in which time zone usage information such as charging average time of each time zone of each charging station, etc. is stored, and a usage statistic data base 37D in which statistic data of usage situations of registered users are stored.

Here, data of the charging average time (average time and standard deviation) for each registered user are stored every time zone of one day, every day of the week, every month, every season, every charging station, etc. in the usage statistic data base 37D. When an estimated charging time is greatly deviated from the charging average time, the estimated charging time is corrected and updated so as to approach to the charging average time.

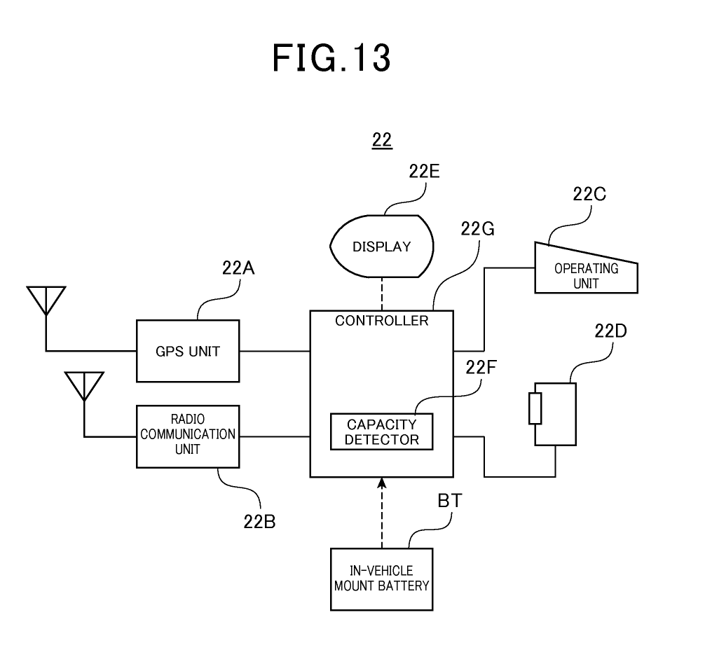

FIG. 13 is a block diagram showing the construction of the in-vehicle mount equipment.

Next, the construction of the in-vehicle mount equipment 22 will be described.

Next, the construction of the in-vehicle mount equipment 22 will be described.

The in-vehicle mount equipment 22 has a GPS unit 22A for receiving positioning electric waves from a GPS satellite to detect the present position of a vehicle in which the in-vehicle mount equipment 22 itself is mounted, a radio communication unit 22B for performing communications with the radio communication device 21, an operating unit 22C for performing various kinds of operations by a crewmember as a driver, a handy microphone 22D for performing radio communication with voices, a display 22E for displaying various kinds of information such as a navigation screen, a charging allocation time, charging station information, etc., a capacity detector 22F for detecting the residual capacity of the in-vehicle mount battery BT, and a controller 22G for concentrically controlling the overall in-vehicle mount equipment.

Here, the capacity detector 22F detects the residual capacity on the basis of the voltage of the in-vehicle mount battery.

Next, the vehicle charging allocation management processing in the vehicle charging allocation managing server will be described.

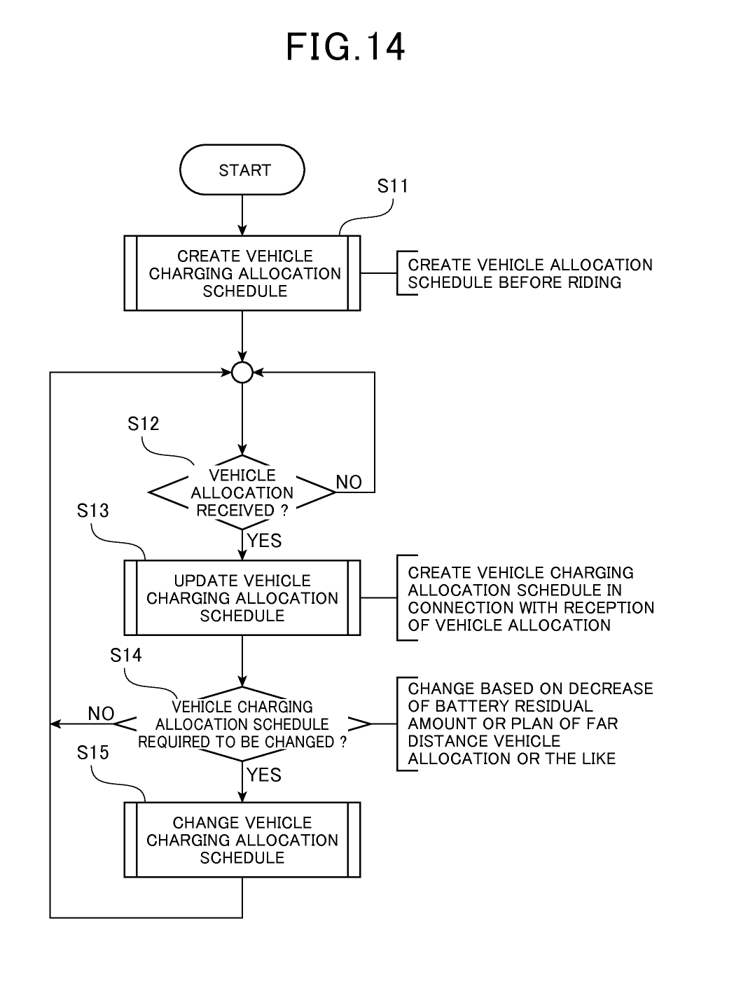

FIG. 14 is a flowchart showing the vehicle charging allocation management processing.

First, the flow of the vehicle charging allocation management processing is be briefly described.

In the vehicle charging allocation management processing, the vehicle charging allocation managing server 23 first creates a vehicle charging allocation schedule for all business vehicles MV which are subjected to operation control by the working control terminal 13 (step S11).

Next, it is determined in the working control terminal 13 whether vehicle allocation is accepted or not (step S12).

When the vehicle allocation is not accepted in the determination of the step S12 (step S12; No), the processing is set to a standby state.

When the vehicle allocation is accepted in the determination of the step S12 (step S12; Yes), the vehicle charging allocation schedule is updated as occasion demands, for example in such a situation that it becomes impossible to charge a business vehicle MV in a scheduled time zone for vehicle charging allocation due to working of the business vehicle MV concerned which is caused by vehicle allocation (step S13).

Subsequently, the vehicle charging allocation managing server 23 determines whether it is necessary to change the vehicle charging allocation schedule due to decrease in battery residual amount, occurrence of a far-distance vehicle allocation schedule or the like (step S14).

When it is unnecessary to change the vehicle charging allocation schedule in the determination of the step S14 (step S14; No), the processing is shifted to the step S12 again to execute the same processing.

On the other hand, when it is required to change the vehicle charging allocation in the determination of the step S14 (step S14; Yes), the vehicle charging allocation schedule is changed (step S15), and then the processing is shifted to the step S12 again to execute the same processing.

As a result, according to this embodiment, charging can be performed with suppressing disturbance of the working of the business vehicle as much as possible.

The vehicle charging allocation management processing will be described hereunder in detail.

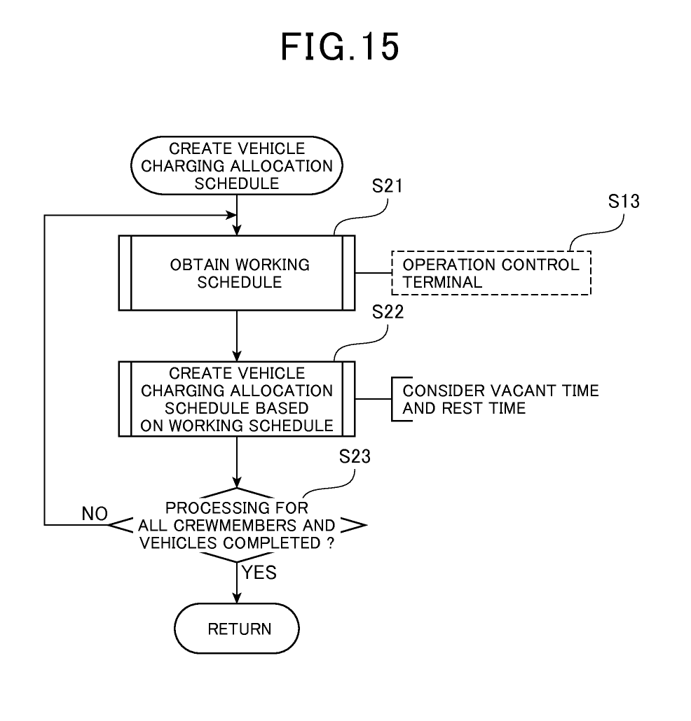

FIG. 15 is a flowchart showing processing of creating a vehicle charging allocation schedule.

According to the processing of creating the vehicle charging allocation schedule in the step S11 of the vehicle charging allocation management processing, the vehicle charging allocation managing server 23 obtains a working schedule of the day from the working control terminal 13, and stores the working schedule into the working DB 51 (step S21).

Subsequently, the vehicle charging allocation managing server 23 creates the vehicle charging allocation schedule on the basis of the obtained working schedule in consideration of a working vacant time and a rest time of each crewmember which correspond to a working schedule of crewmembers, a vehicle status (during working, during checking or the like) (step S22).

Specifically, the vehicle charging allocation managing server 23 refers to the working schedule of the day and inquires to the charging station managing servers 24-1, 24-2 to make charging reservations to the charging station managing servers 24-1, 24-2 so that each business vehicle MV can be charged in a time zone where the crewmember of the business vehicle MV is expected to take a rest if at all possible, thereby creating the vehicle charging allocation schedule.

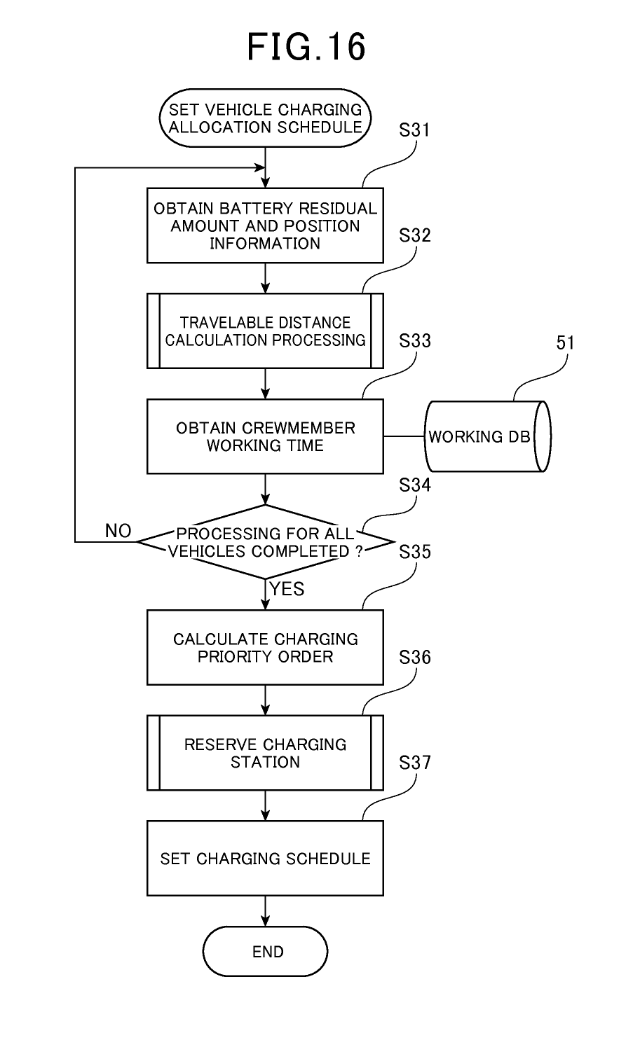

FIG. 16 is a flowchart showing the processing of setting the vehicle charging allocation schedule.

First, the vehicle charging allocation managing server 23 obtains the battery residual capacity and the position information from the in-vehicle mount equipment 22 of each business vehicle MV through the radio communication device 21 (step S31).

Subsequently, the travelable distance of each business vehicle MV is calculated on the basis of the obtained battery residual capacity (step S32).

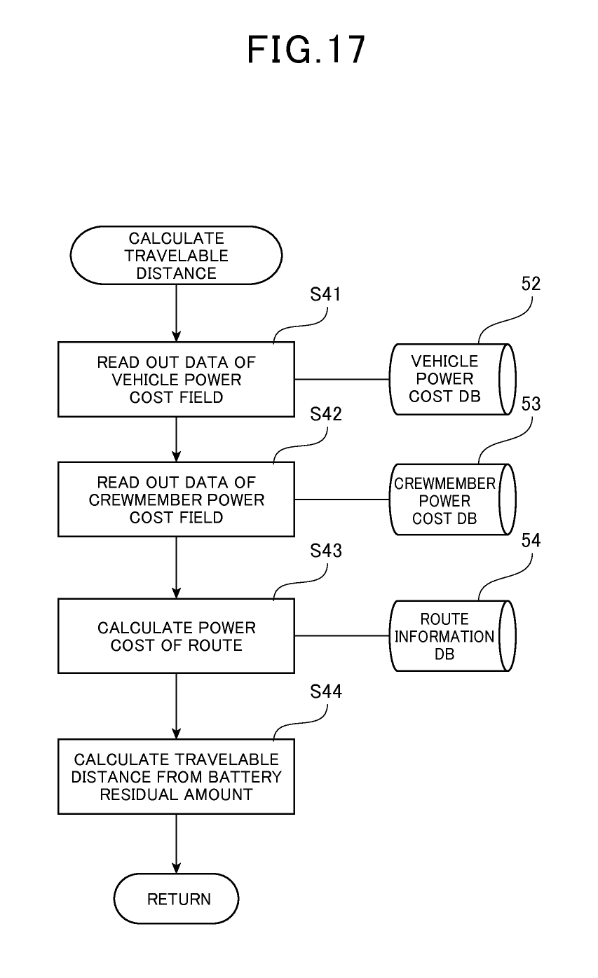

FIG. 17 is a flowchart showing the processing of calculating the travelable distance.

First, the vehicle charging allocation managing server 23 refers to the vehicle power cost data base 52 to read out the vehicle power cost table 52B in which a travelable distance per unit battery capacity (power cost) of each business vehicle is stored in association with travel conditions such as the type of a road (general road or express highway), the condition of a road (flat road, descending slope, ascending slope, intermountain road or the like), the condition of a vehicle (use or non-use of air conditioner, turn-on/out of headlight, use or non-use of a wiper, use or non-use of in-vehicle mount accessory equipment such as CD player or the like), etc. (step S41).

Subsequently, the vehicle charging allocation managing server 23 refers to the crewmember power cost data base 53 to read out the crewmember power cost table 53B in which a travelable distance per unit battery capacity (power cost) of each crewmember is stored in association with travel conditions such as such as the type of a road (general road or express highway), the condition of a road (flat road, descending slope, ascending slope, intermountain road or the like), the condition of a vehicle (use or non-use of air conditioner, turn-on/out of headlight, use or non-use of wiper, use or non-use of in-vehicle mount accessory equipment such as CD player or the like), etc. (step S42).

Subsequently, the vehicle charging allocation managing server 23 refers to the route information DB 54 to arbitrarily set an average travel route containing an average road condition in a normal working and refers to the data of the vehicle power cost table 52B and the data of the crewmember power cost table 53B to calculate the power cost of the route concerned (step S43). That is, the average power cost when each crewmember drives the business vehicle is calculated.

Accordingly, the travelable distance when the business vehicle MO travels along the average travel route is calculated from the present battery residual amount (step S44), and the processing is shifted to step S33 (see FIG. 16).

Subsequently, the vehicle charging allocation managing server 23 obtains the working time of each driver as a crewmember (step S33).

Subsequently, the vehicle charging allocation managing server 23 determines whether the calculation of the travelable distance and the processing of obtaining the crewmember working time are completed for all the vehicles MV (step S33).

When the calculation of the travelable distance and the processing of obtaining the crewmember working time for all the vehicles MV have not yet been completed in the determination of the step S33 (step S33; No), the processing is shifted to the step S31 again, and the same processing is repeated until the calculation of the travelable distance and the processing of obtaining the crewmember working time have been completed for all the vehicles MV.

On the other hand, when the calculation of the travelable distance and the processing of obtaining the crewmember working time are completed for all the business vehicles MV in the determination of the step S33 (step S33; Yes), a charging priority order representing which business vehicle must be preferentially charged is calculated for all the business vehicles (step S35).

With respect to this charging priority order, a business vehicle MV which is required to travel at a longer distance is more preferentially charged than a business vehicle MV having a smaller battery residual capacity. In the case of business vehicles having the same battery residual capacity or the same scheduled travel distance, a business vehicle MV in which a larger number of persons or a larger amount of cargos are assumed to be loaded is more preferentially charged, and a business vehicle MV which is assumed to travel to a district where an air conditioner or a wiper is assumed to be used is more preferentially charged. The charging priority order of these business vehicles MV is set to be high.

The vehicle charging allocation managing server makes a reservation to a charging station in priority to a business vehicle having a high charging priority order (step S36).

Here, the reservation processing of the charging station will be described.

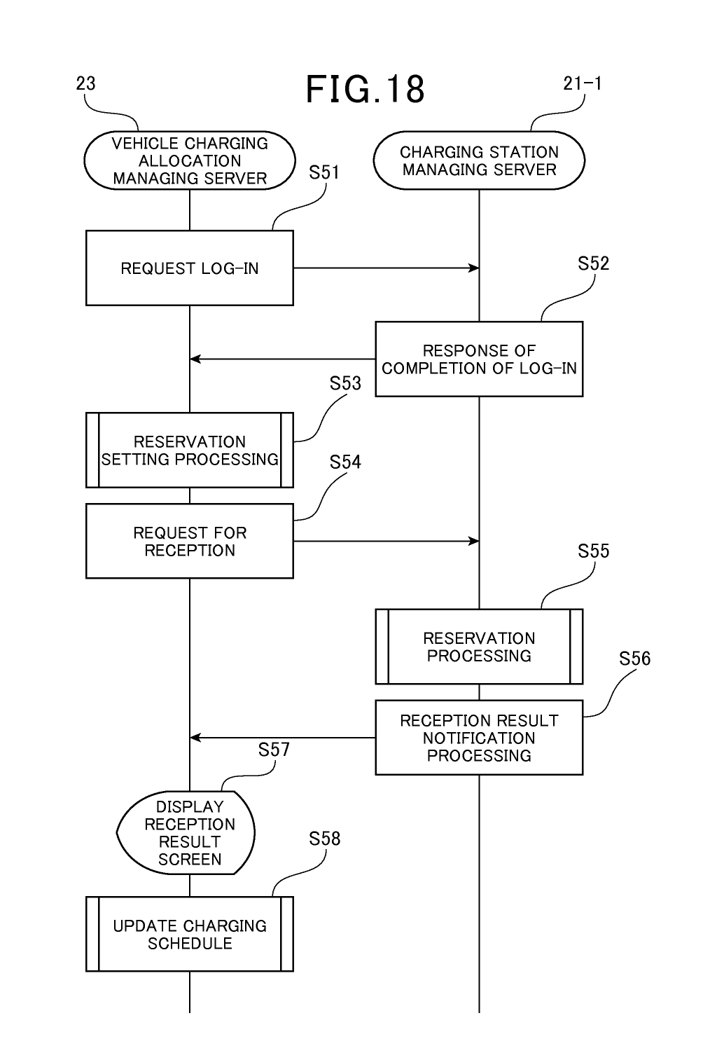

FIG. 18 is a sequence flowchart showing reservation of charging.

In FIG. 18, the description will be made on the assumption that the vehicle charging allocation managing server 23 makes a reservation to the charging station managing server 24-1.

First, the vehicle charging allocation managing server 23 makes a log-in request to the charging station managing server 24-1 through the Internet 12 (step S51).

In this case, the log-in request is made by using a pre-issued user ID. Here, in addition to the user ID, a digital signature of the vehicle charging allocation managing server 23 or the like is used as information for user authentication at the charging station managing server 24-1 side.

When the log-in is completed, the charging station managing server 24-1 outputs a log-in completion response (step S52). Accordingly, the vehicle charging allocation managing server 23 executes reservation setting processing (step S53).

Specifically, the vehicle charging allocation managing server 23 executes the reservation setting processing so as to make a reservation for charging early from a business vehicle MV having a higher priority according to the charging priority order calculated in step S35 so that charging can be performed before the battery residual capacity of each business vehicle MV decreases excessively.

That is, a charging station (or charging stand group) to which reservation is desired, a desired reservation date and hour (time zone), information for specifying a reservation target vehicle, a charging time, the number of business vehicles, etc. are set in the reservation setting processing. In this case, charging stations maybe specified by specifying plural desired charging stations over plural areas like a first desired charging station and a second desired charging station.

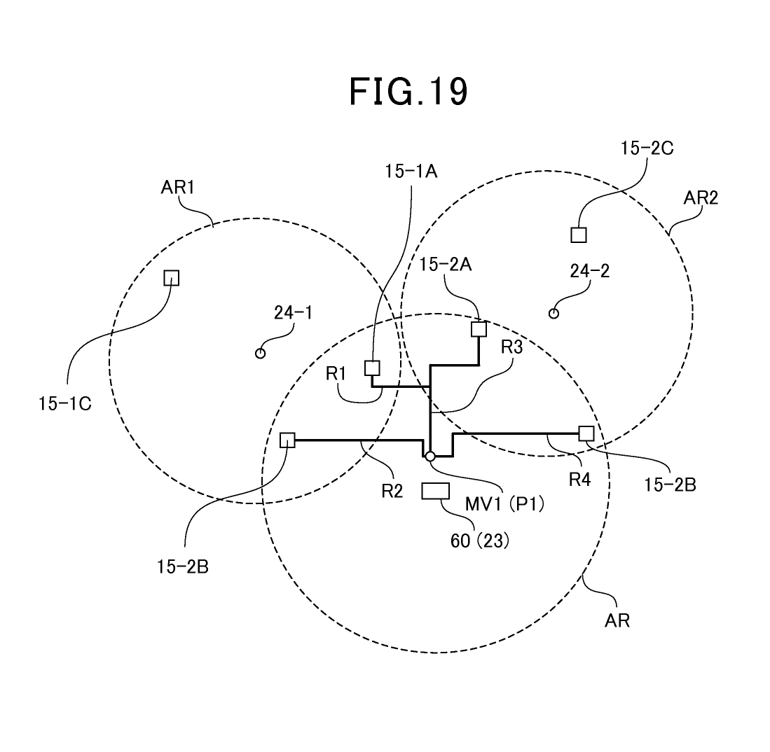

FIG. 19 is a diagram showing the specification of the charging station.

A business area in which a business office 60 having the vehicle charging allocation managing server 23 is located and business vehicles MV work (run) is represented by AR. It is assumed that the charging stations 15-1A and 15-1B out of the charging stations 15-1A to 15-1C under the management of the charging station managing server 24-1 and the charging stations 15-2A and 15-2B out of the charging stations 15-2A to 15-2C under the management of the charging station managing server 24-2 are located within the business area AR. When a charging target business vehicle MV is located at the business office 60, the vehicle charging allocation managing server 23 compares a route R1 extending from the business office 60 to the charging station 15-1A, a route R2 extending from the business office 60 to the charging station 15-1B, a route R3 extending from the business office 60 to the charging station 15-2A and a route R4 extending from the business office 60 to the charging station 15-2B. In this case, when R1<R3<R4<R2 is satisfied, a first desired charging station is set to the charging station 15-1A, and a second desired charging station is set to the charging station 15-2A.

In this case, in principle, the vehicle charging allocation managing server 23 searches a chargeable charging station in the business area AR. However, when a chargeable charging station is not searched within the business area AR from the viewpoint of the charging time zone or the like, a charging station which is located at a position which is as near to the present position of the business vehicle MV as possible is set to a desired charging station.

Furthermore, with respect to information for specifying a reservation target vehicle, it may be made common to all the business vehicles MV. Accordingly, a business vehicle MV which is scheduled to travel to an actually reserved charging station may be easily changed after the charging reservation is made.

Through this reservation setting processing, the reservation request content is settled, and the received request is transmitted to the charging station managing server 24-1 side (step S54). Accordingly, the charging station managing server 24 shifts the processing to the reservation processing (step S55).

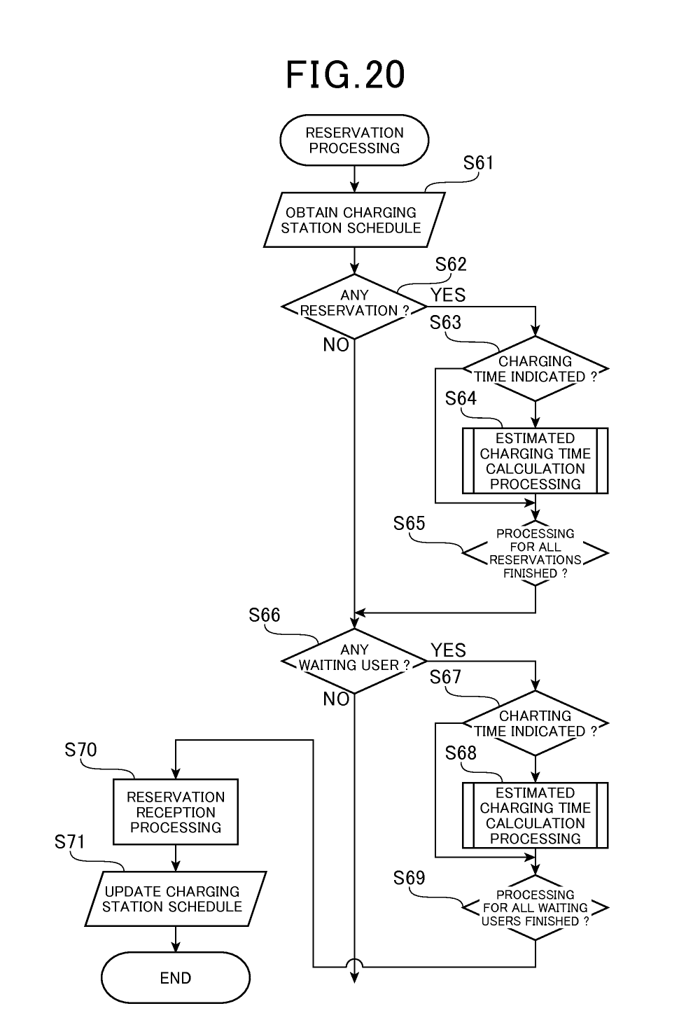

FIG. 20 is a flowchart showing the reservation processing of the charging station managing server.

The charging station managing server 24-1 which has received the reservation request obtains charging station schedules of the charging stations 15-1A to 15-1C (or the respective chargers 34 of the charging stations 15-1A to 15-1C) corresponding to the reservation request concerned from the corresponding station information data bases (step S61).

Subsequently, the charging station managing server 24-1 determines on the basis of the charging station schedules of the charging stations 15-1A to 15-1C as the reservation targets whether there is any reservation before the reservation desired date and hour (step S62).

When there is some reservation in the determination of the step S62 (step S62; Yes), it is determined whether the vehicle charging allocation managing server 23 indicates the charging time for the reservation corresponding to the reservation request concerned (step S63).

When the vehicle charging allocation managing server 23 indicates the charging time in the determination of the step S33 (step S63; Yes), the processing is shifted to the step S65.

When the vehicle charging allocation managing server 23 does not indicate any charging time in the determination of the step S63 (step S63; No), estimated charging time calculation processing of calculating an estimated charging time is executed (step S64).

Here, the estimated charging time calculation processing will be described.

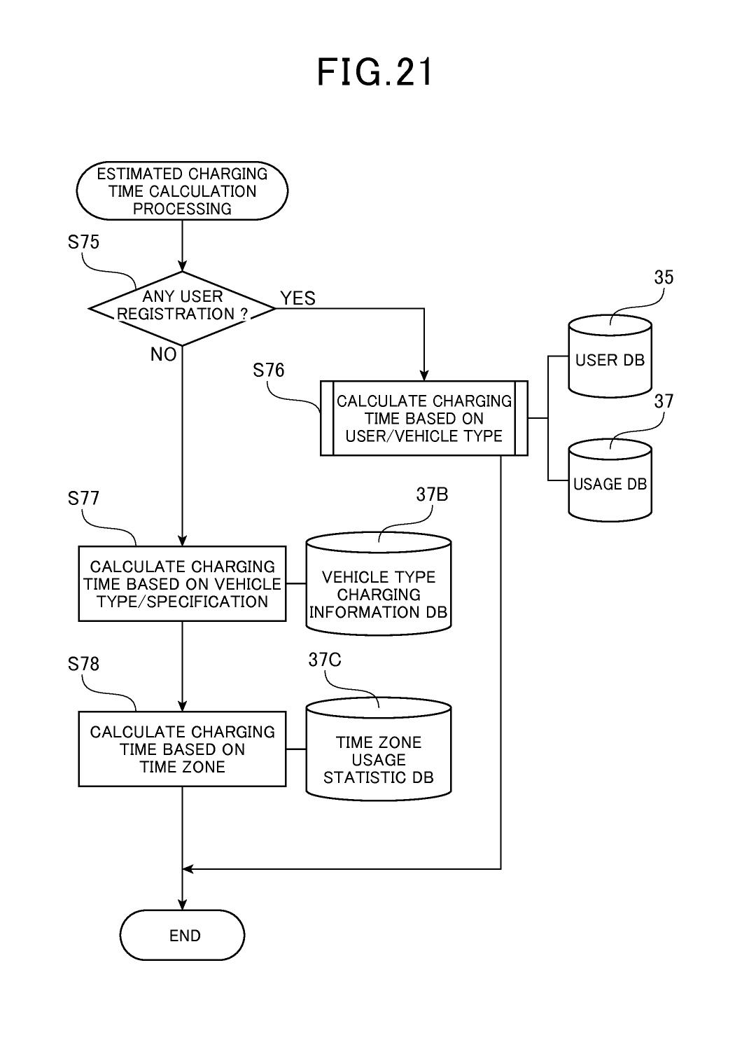

FIG. 21 is a flowchart showing the estimated charging time calculation processing.

First, the charging station managing server 24-1 determines whether the reservation is a user-registered reservation of the vehicle charging allocation managing server 23 (step S75).

When the user registration has been executed in the vehicle charging allocation managing server 23 in the determination of the step S75 (step S75; Yes), the charging time based on the vehicle type is calculated on the basis of the information for specifying the reservation target vehicle (step S76).

Specifically, the charging station managing server 24-1 refers to the pre-stored user data base to grasp the capacities, types, number, etc. of in-vehicle mount batteries mounted in a vehicle which is reserved to be charged by the vehicle charging allocation managing server 23.

With respect to these information, when the vehicle type (grade, specification) is settled, the capacities, types and number of the mounted batteries are normally settled. Accordingly, the determination is made on the basis of the vehicle type.

It is known that the time required to charge the in-vehicle mount battery greatly varies in accordance with the charging state and degradation level of the battery. For example, with respect to aged deterioration, the capacity is reduced to about 70% for ten years, and thus the time required for charging varies greatly. Furthermore, when the actual capacity (residual capacity) of the battery is large, the charging time is relatively short, and when the actual capacity (residual capacity) of the battery is small, the charging time is relatively long.

Therefore, according to this embodiment, the determination based on the vehicle type is corrected by referring to a usage data base in which usage statistic data are stored. The usage statistic data are obtained by statistically processing charging conditions when the registered user concerned past used the charging stations for the charging target vehicle. For example, when the aged deterioration described above is considered, the time required for charging is corrected by using the movement average value of the battery capacity.

Furthermore, with respect to the charging target vehicle, that is, user, there is some degree of trend in the battery charging condition (battery charging state, day of the week, time zone, season, weather), etc., and thus there is a trend in estimation error which corresponds to the difference between the actual charging time and the estimated charging time in each case. Therefore, the estimated charging time can be accurately calculated by using the usage statistical data.

Specifically, an estimated battery residual amount at a predetermined timing (time zone, day of the week, season, weather) of each registered user is calculated, and a charging estimation time when charging is performed according to a charging method (a charging pattern based on a set value such as charging current, charging voltage or the like) which is specified by the vehicle of the registered user is calculated.

First, the time zone will be described.

The charging time required in a normally used time zone and the charging time required in a time zone which is not normally used have different trends. This difference in trend would occur because charging is performed in good time in the normally-used time zone, and the battery residual amount would have substantially the same trend.

The day of the week likewise has some degree of trend. For example, with respect to days on which traffic jam may occur with high probability like Saturday and Sunday, it is expected that the power consumption increases and thus the charging time is longer, and thus the charging time is increased by 5%.

Furthermore, with respect to the time zone, a light containing a headlight is turned on when nighttime comes or in a traffic-jam time zone, the power consumption increases and thus the estimated charging time is longer. Therefore, the estimated charging time is increased by 5%.

With respect to the season, in the case of an electric vehicle, power consumption is larger than usual in a season where an air conditioner (a cooler, a heater) or the like is used, and thus the charging frequency is increased. However, it has a trend that the battery residual amount under charging is less as compared with a case where the air conditioner, etc. are not used, and thus it is necessary to estimate the charging time while reflecting such a trend. More specifically, it is expected that the battery residual amount is less in the winter season because a heater is used and thus the estimated charging time is expected to be longer. Therefore, the estimated charging time is increased by 20%. Furthermore, it is also expected that the battery residual amount is less in the summer season because a cooler is used and thus the estimated charging time is longer. Therefore, the estimated charging time is increased by 10%, for example.

With respect to the weather, it is necessary to actuate a wiper under rain or the like, and thus the estimated charging time is expected to be longer, so that the estimated charging time is increased by 5%, for example. Accordingly, the charging time can be more accurately estimated by obtaining the usage statistic data on the basis of the time zone, the season, etc.

On the other hand, when the user registration has not been executed in the determination of the step S75, for example in the case of a new user (step S75; No), the vehicle type charging information data base 37B is referred to and a charging time is calculated (estimated) on the basis of the vehicle type and the specification, the locations of the charging stations, the types of installed chargers, etc. (step S77).

Specifically, the number, capacities and types of batteries mounted in a charging target vehicle are determined on the basis of the vehicle type/specification, and also the age of service, etc. can be estimated. Therefore, a standard charging time of the batteries is calculated. Furthermore, the calculated charging time is corrected on the basis of the location of the charging station and the type of the installed charger.

That is, the standard charging time is determined on the basis of the number, capacities and types of the batteries by referring to the vehicle type charging information data base 37B, deterioration is taken into consideration on the basis of the estimated age of service, and further the estimated charging time is calculated on the basis of the location of the charging station and the type of the installed charger.

In this case, when only the vehicle type/specification are known, a standard charging time determined from the pre-stored vehicle type is used in place of the calculation of the charging time.

Subsequently, the charging station managing server 24-1 corrects the charging time calculated in step S77 inconsideration of the time-zone based average charging time, thereby calculating a more accurate estimated charging time (step S78), and then shifts the processing to step S65.

The charging station managing server 24-1 determines whether the processing for all reservations is finished or not (step S65).

When the processing for all the reservation has not yet been finished in the determination of the step S65 (step S65; No), the charging station managing server 24-1 shifts the processing to the step S63 again to execute the same processing, and execute the calculation processing of the estimated charging time for all reservations in which no charging time is specified (step S64).

When there is no reservation in the determination of the step S62 (step S62; No) or when the estimated charging time calculation processing for all the reservations is finished in the determination of the step S65 (step S65; Yes), the charging station managing server 24-1 determines on the basis of the obtained charging station schedules of the reservation target charging stations 15-1A to 15-1C whether there is any waiting user who waits for his/her charging turn on a reservation desired date indicated as a reservation desired date and hour (step S66). Actually, a user who waits for his/her charging turn is expected to exist only when the reservation desired date is the current day, and thus when the reservation desired date is out of the current day, there is no user waiting for his/her charging turn, and thus the determination of the step S66 is “No”.

When there is a user who waits for his/her charging turn in the determination of the step S65 (step S66; Yes), it is determined whether the charging-turn waiting user concerned specifies a desired charging time (step S67). When the user concerned specifies the desired charging time in the determination of the step S67 (step S67; Yes), the processing is shifted to step S69.

When the user concerned does not specify any desired charging time in the determination of the step S67 (step S67; No), the estimated charging time calculation processing of calculating the estimated charging time for the charging-turn waiting user concerned is executed (step S68).

Subsequently, the charging station managing server 24-1 determines whether the processing for all the charging-turn waiting users is finished or not (step S69).

When the processing has not yet been finished for all the charging-turn waiting users in the determination of the step S69 (step S69; No), the charging station managing server 24-1 shifts the processing to the step S67 again to execute the processing, and executes the estimated charging time calculation processing for all the charging-turn waiting users who do not specify any desired charging time (step S68).

When there is no charging-turn waiting user in the determination of the step S66 (step S66; No) or when the estimated charging time calculation processing for all the charging-turn waiting users is finished in the determination of the step S69 (step S69; Yes), the charging station managing server 24-1 executes reservation accepting processing for notifying an accept result described later (step S70).

Accordingly, the reservation request content is settled, and the charging station managing server 24-1 updates the charging station schedule of the charging stations 15-1A to 15-1C as reservation targets on the station information data base in which the reservation schedule is stored (step S71), and finishes the reservation processing (step S55).

Subsequently, the charging station managing server 24-1 executes reception result notification processing of notifying reception of the reservation and the charging station reservation information to the vehicle charging allocation managing server 23(step S56).

Accordingly, the vehicle charging allocation managing server 23 displays the reception result on the screen on the basis of the reception result notification (step S57), and installs the obtained charging station reservation information as a charging allocation schedule (step S58).

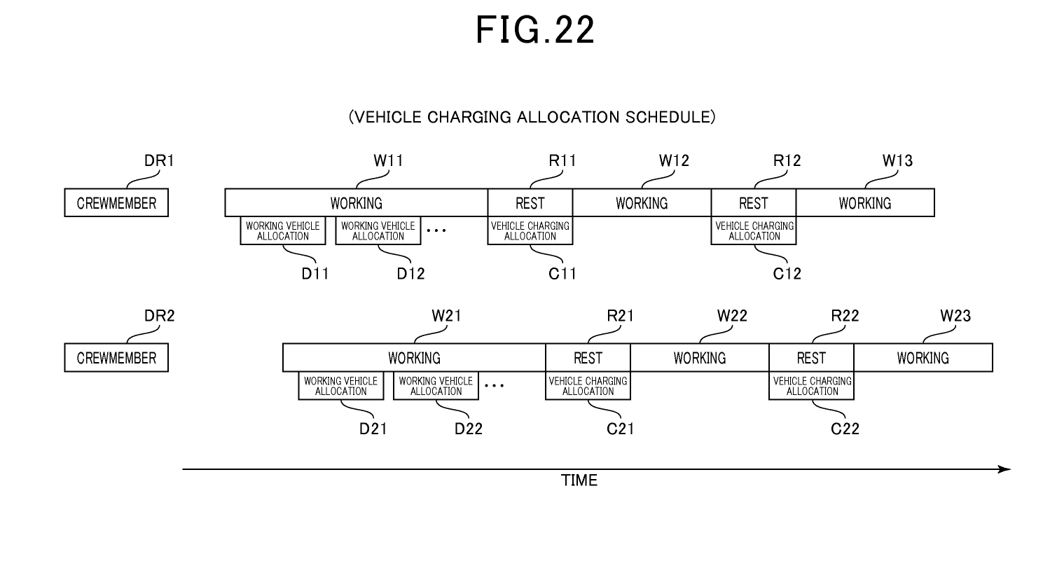

FIG. 22 is an example of the creation of the charging allocation schedule.

FIG. 22 shows a working schedule (working allocation schedule) of a first crewmember DR1 and a second crewmember DR2.

In the working schedule of the crewmember DR1, a second working time zone W12 is allocated after a first working time zone W11 so that a rest time zone R11 is interposed between the first and second working time zones W11 and W12. Furthermore, a third working time zone W13 is allocated after the second working time zone W12 so that a rest time zone R12 is interposed between the second and third working time zones W12 and W13.

At the present time point, working allocation schedules D11, D12, . . . are set in the first working time zone W11. Here, the working allocation schedule contains an emergent vehicle allocation schedule such as vehicle allocation based on a customer's telephone request or the like and a periodical vehicle allocation schedule such as periodic vehicle allocation for periodically getting persons to and from nursing and personal care facilities or the like.

Furthermore, a first vehicle charging allocation schedule C11 is set in the rest time zone R11, and a second vehicle allocation schedule C12 is set in the rest time zone R12.

Likewise, in the working schedule of the crewmember DR2, a second working time zone W22 is allocated after a first working time zone W21 so that a rest time zone R21 is interposed between the first and second working time zones W21 and W22. Furthermore, a third working time zone W23 is allocated after the second working time zone W22 so that a rest time zone R22 is interposed between the second and third working time zones W22 and W23.

At the present time point, working allocation schedules D21, D22, . . . are set in the first working time zone W21. A first vehicle charging allocation schedule C21 is set in the rest time zone R21, and a second vehicle allocation schedule C22 is set in the rest time zone R22.

In these cases, in order to enhance the operation (working) efficiency of vehicles, the vehicle charging allocation schedules C11, C12 are set in the time zones corresponding to the rests R11, R12 of the crewmember DR1, and the vehicle charging allocation schedules C21, C22 are set in the time zones corresponding to the rests R21, R22 of the crewmember DR2.

Subsequently, the processing is shifted to the processing of FIG. 14 again to determine whether reception of vehicle allocation is executed or not on the basis of a vehicle allocation request through the Internet 12 or by a manual input of an operator who receives a vehicle allocation request through a telephone (step S12).

When no reception of vehicle allocation is executed in the determination of the step S12 (step S12; No), the processing is set to a standby state.

When the reception of the vehicle allocation is executed in the determination of the step S12 (step S12; Yes), the vehicle charging allocation schedule is updated on the basis of the working schedule and the charging schedule at the present time point as occasion demands, and the vehicle charging allocation schedule is changed to a time zone which does not affect the vehicle allocation schedule corresponding to the reception of the vehicle allocation.

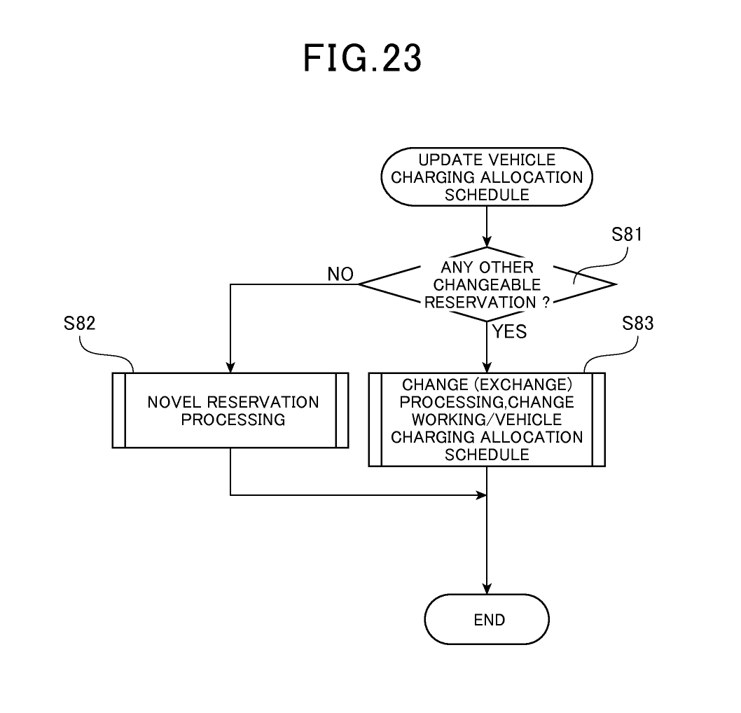

FIG. 23 is a flowchart showing the processing of updating the vehicle charging allocation schedule.

Here, the processing of changing the vehicle charging allocation schedule will be described more specifically.

The vehicle charging allocation managing server 23 determines whether there are charging reservations which have been already made in the charging station managing server 24-1 or 24-2 for business vehicles other than a specific business vehicle and whose business vehicles are changeable to the specific business vehicle (step S81).

When there is no other vehicle-changeable charging reservation in the determination of the step S81 (step S81; No), the vehicle charging allocation managing server 23 newly executes the charging reservation processing on the charging station managing servers 24-1 and 24-2 for the specific vehicle(step S82).

When there is a changeable charging reservation in the determination of the step S81 (step S81; Yes), the vehicle charging allocation managing server 23 executes the processing of changing the charging reservation (change of the corresponding vehicle, change of authentication proceeding of the corresponding crewmember or the like), and also executes the processing of changing the working schedule and the vehicle charging allocation schedule which are managed by the vehicle charging allocation managing server 23 itself (step S83).

Subsequently, the vehicle charging allocation managing server 23 determines whether it is necessary to change the vehicle charging allocation schedule due to decrease of the battery residual amount, the far-distance vehicle allocation plan or the like (step S14).

When it is unnecessary to change the vehicle charging allocation schedule in the determination of the step S14 (step S14; No), the processing is shifted to the step S12 again, and the same processing is executed.

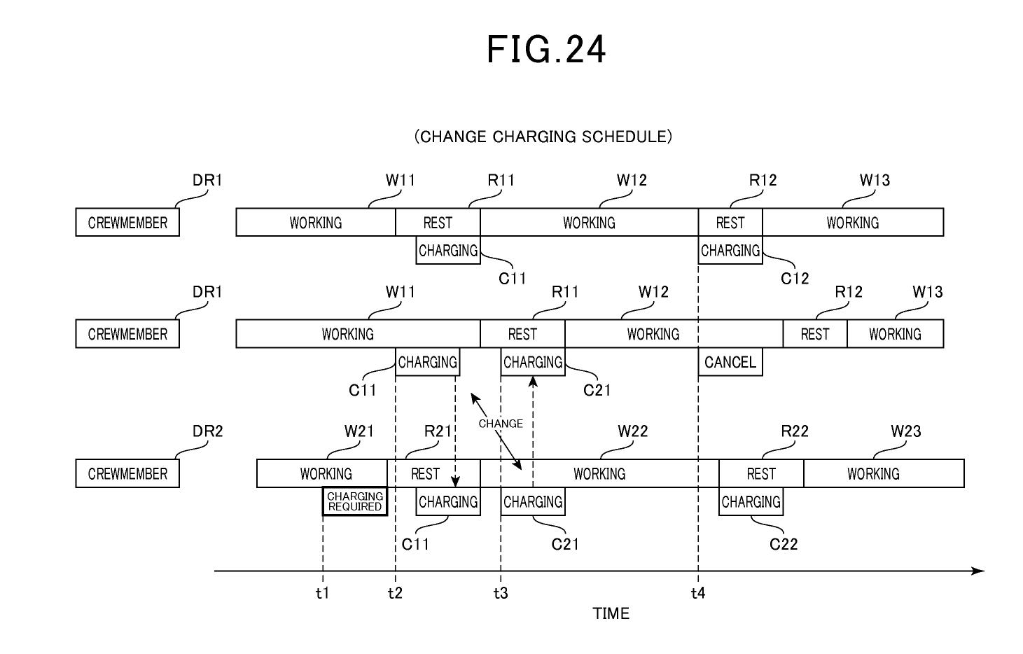

FIG. 24 is a diagram showing the processing of changing the vehicle charging allocation schedule.

At an initial state, as shown at the upper stage of FIG. 24, a first vehicle charging allocation schedule C11 is set in a rest time zone R11, and a second vehicle charging allocation schedule C12 is set in a rest time zone R12.

Here, when there occurs such a situation that necessity of charging for some business vehicle (second crewmember DR2) is determined at a time t1 of the first working time zone W21 of the working schedule of the second crewmember DR2 as shown in FIG. 24, the vehicle charging allocation managing server 23 determines whether there are any charging reservations which have been already made in the charging station managing server 24-1 for business vehicles other than the specific business vehicle and whose business vehicles are changeable to the specific business vehicle (step S81).

In this case, there exists the vehicle charging allocation schedule C11 for the business vehicle driven by the crewmember DR1, a charging reservation (time t2) thereof being changeable for the specific business vehicle of the crewmember DR2. It is assumed that the battery residual amount of the vehicle of the crewmember DR1 is not affected by a little change of the vehicle charging allocation schedule. Accordingly, the vehicle charging allocation managing server 23 changes the vehicle charging allocation schedule C11 to the rest time zone R21 of the working schedule for the second crewmember DR2.

Furthermore, the rest time zone R11 of the first crewmember DR1 is changed to the rest time zone R11′ corresponding to the vehicle charging allocation schedule C21 in the working schedule of the second crewmember DR2, and the vehicle charging allocation schedule C21 at the time t3 in the working schedule of the second crewmember DR2 is changed to the rest time zone R11′ in the changed working schedule of the first crewmember DR1.

When it is consequently unnecessary to charge the business vehicle of the crewmember DR1 at time t4 in the original vehicle charging allocation schedule C12, the vehicle charging allocation schedule C12 itself is canceled, and this fact is notified to the charging station managing server 24-1.

As described above, when there are charging reservations which have been already made in the charging station managing server 24-1 for business vehicles other than some business vehicle and further whether there is any one of these charging reservations whose business vehicle is changeable to the specific business vehicle, these charging reservations may be mutually changed to one another so that the charging schedules of the business vehicles are interchanged with one another without executing any new charging reservation, thereby performing efficient charging.

In this case, a vehicle for which a charging reservation is made and a vehicle which is actually charged are different, and thus it is necessary to standardize information for specifying respective business vehicles MV so that authentication is performed in the charging stations 15-1A to 15-1C with no problem under charging.

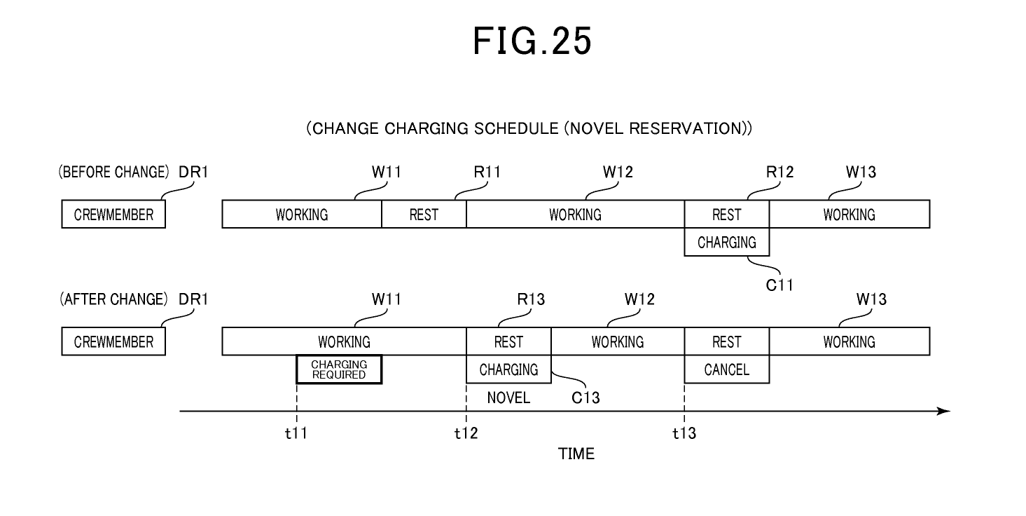

FIG. 25 is a diagram showing the processing of changing the vehicle charging allocation schedule “new reservation”.

In this case, as shown at the upper stage of FIG. 24, it is assumed that the vehicle charging allocation schedule 11 is set in the rest time zone R12 of the crewmember DR1 under the initial state.

Here, when there occurs such a situation that necessity of charging is determined in the first working time zone W11 of the working schedule of the crewmember DR1, the vehicle charging allocation managing server 23 determines whether there are any charging reservations which have been already made in the charging station managing server 24-1 for business vehicles other than the business vehicle of the crewmember DR1 and whose business vehicles are changeable to the business vehicle of the crewmember DR1 (step S81). In this case, there is no charging reservation whose business vehicle is changeable to the business vehicle of the crewmember DR1, and thus the vehicle charging allocation managing server 23 makes a new charging reservation at time t12, and also changes the rest time zone R11 set at the time t12 to a rest time zone R13 so that a new vehicle charging allocation schedule C13 is contained in the rest time R13.

As a result, the original vehicle charging allocation schedule C11 set at the time t13 is canceled, and this fact is notifies to the charging station managing server 24-1.

As described above, the new charging reservation is made when there is no charging reservation which has been already made in the charging station managing server 24-1 for business vehicles other than a specific business vehicle and whose business vehicles are changeable to the specific business vehicle, and the existing charging reservation for the specific business vehicle is canceled, whereby the charging can be performed without affecting the working schedule of the business vehicles.

As described above, according to this embodiment, even when the operation control of plural vehicles is performed, the vehicle charging allocation schedule can be managed with suppressing the effect on the operation control.

Accordingly, charging can be performed with reducing the waiting time, and loss of business opportunity during charging or under an out-of-power state can be suppressed.

Furthermore, when this embodiment is applied not to an electric vehicle (electric car), but to a plug-in hybrid vehicle, the vehicle can be made to run with electric power more frequently than gasoline. Therefore, the vehicle operation cost can be reduced.

In the foregoing description, the vehicle charging allocation managing server 23 and the working control terminal 13 are provided separately from each other, however, the working control function may be installed in the vehicle charging allocation managing server 23.

In the foregoing description, the working control terminal 13 is not directly connected to the Internet 12, however, a vehicle (taxi or the like) allocation request may be directly made by a user through the Internet 12.

Furthermore, in the foregoing description, the management of the vehicle charging allocation schedule for business vehicles under the control of a taxi business company. However, the management of the vehicle charging allocation schedule of business vehicles under control can be constructed in a rental car business company, a car sharing business company, a bus business company, a transport business company using vehicles such as trucks, etc.

still furthermore, when this invention is applied to the taxi business company or the rental car business company, by providing a sightseeing model course in advance, a vehicle charging allocation schedule may be set in a time zone where a user who utilizes a taxi or rents a car gets out of the car to do sightseeing, thereby making the users unconscious of charging time.

What is claimed is:

1. A vehicle charging allocation managing server for managing charging of a plurality of vehicles each of which has a vehicle driving battery mounted therein, comprising a controller for setting a vehicle charging allocation schedule for specifying a charging station and a charting time zone to charge each of the vehicles on the basis of a battery residual capacity and a battery capacity consumption plan, thereby performing vehicle allocation for charging.

2. The vehicle charging allocation managing server according to claim 1, wherein the controller determines the battery capacity consumption plan for each of the vehicles on the basis of a predetermined working schedule for the vehicle.

3. The vehicle charging allocation managing server according to claim 2, wherein each of the vehicles is a business vehicle for which an operation schedule containing the working schedule and a rest schedule is managed, and the controller obtains the operation schedule and determines the battery capacity consumption plan on the basis of the obtained operation schedule.

4. The vehicle charging allocation managing server according to claim 3, wherein when the operation schedule of any one of the vehicles is changed and thus a vehicle charging allocation schedule of the vehicle is required to be changed, the controller adjusts and changes the vehicle charging allocation schedule and vehicle charging allocation schedules of the other vehicles.

5. The vehicle charging allocation managing server according to claim 1, wherein the charging station is managed by a charging station managing server, and the controller inquires to the charging station managing server about a usage status of the charging station corresponding to the charging station managing server through a communication network to specify the charging station and the time zone for charging.

6. The vehicle charging allocation managing server according to claim 1, wherein the controller calculates the battery capacity consumption plan for each of the vehicles on the basis of at least one of a travel condition containing season, weather or a time zone, a device construction of the vehicle, a crewmember of the vehicle or a travel route.

7. The vehicle charging allocation managing server according to claim 1, wherein the controller notifies a vehicle charging allocation schedule to an in-vehicle mount device mounted in each of the vehicles through a radio communication network.

8. A vehicle charging allocation managing system for managing charging of a plurality of vehicles each of which has a vehicle driving battery, comprising:
a plurality of charging stations each of which has a battery charger for charging the battery of each of the vehicles;
a charging station managing server for managing the charging stations; and
a vehicle charging allocation managing server that is connected to the charging station managing server through a communication network, and instructs vehicle allocation to allocate each of the vehicles to an appropriate one of the charging stations for charging, wherein the vehicle charging allocation managing server comprises a controller for setting a vehicle charging allocation schedule for specifying a charging station and a charting time zone to charge each of the vehicles on the basis of a battery residual capacity and a battery capacity consumption plan, thereby performing vehicle allocation for charging.
